(19) United States
(12) Patent Application Publication
(10) Pub. No.: US 2013/0273407 A1
(43) Pub. Date: Oct. 17, 2013

(54) HEAT RESISTANCE LAYER FOR NONAQUEOUS SECONDARY BATTERY, PROCESS FOR PRODUCING THE SAME, AND NONAQUEOUS SECONDARY BATTERY

(71) Applicant: EnerDel, Inc., Greenfield, IN (US)

(72) Inventors: Kostyantyn KYLYVNYK, Pompano Beach, FL (US); Naoki OTA, Fishers, IN (US); Hiroyuki YUMOTO, Fishers, IN (US)

(21) Appl. No.: 13/897,137

(22) Filed: May 17, 2013

Related U.S. Application Data
(63) Continuation of application No. PCT/US2011/063122, filed on Dec. 2, 2011.
(60) Provisional application No. 61/419,618, filed on Dec. 3, 2010.

(51) Int. Cl. H01M 10/0562; H01M 2/16; H01M 10/0525; H01M 4/131

(52) U.S. Cl. CPC H01M 10/0562; H01M 4/131; H01M 2/1673; H01M 10/0525
USPC 429/144; 429/209; 429/320; 429/322; 429/231.1; 427/58; 427/126.3

(57) ABSTRACT

A non-aqueous electrochemical cell is disclosed having a heat-resistant coating on at least one of a negative electrode, a positive electrode, and a separator, if provided. The heat-resistant coating may consume heat in the cell to stabilize the cell, act as an electrical insulator to prevent the cell from short circuiting, and increase the mechanical strength and compression resistance of the coated component. In certain embodiments, the heat-resistant coating serves as a solid state electrolyte to produce a solid state electrochemical cell.

### CROSS REFERENCE TO RELATED APPLICATION

This application is a continuation of PCT Patent Application Serial No. PCT/US2011/063122, filed Dec. 2, 2011, titled HEAT-RESISTANT LAYER FOR NON-AQUEOUS AND SOLID STATE BATTERY AND METHOD OF MANUFACTURING THE SAME and claims the benefit of U.S. Provisional Patent Application Ser. No. 61/419,618, filed Dec. 3, 2010, the disclosures of which are hereby expressly incorporated by reference herein in its entirety.

### FIELD OF THE DISCLOSURE

The present disclosure relates to a non-aqueous electrochemical cell and, more particularly, to a non-aqueous electrochemical cell having a heat-resistant coating and to a method of manufacturing the same.

### BACKGROUND OF THE DISCLOSURE

A secondary electrochemical cell, such as a lithium-based electrochemical cell, includes a negative electrode (or anode) and a positive electrode (or cathode). Between the negative and positive electrodes, the cell includes a non-aqueous electrolyte. In use, lithium ions travel between the negative and positive electrodes to generate power.

As technology develops, higher energy densities, higher capacities, and higher outputs are being demanded from these cells. These performance demands are especially high in automotive applications where the cells are designed for use in hybrid electric vehicles (HEV's) or electric vehicles (EV's), for example. In light of these high performance demands, the industry has tried to improve the stability and safety of the cells.

In one application, a porous or microporous separator may be positioned between the negative and positive electrodes to separate the electrodes and to stabilize the cell. The separator is typically a porous or microporous polymer thin film (e.g., 10-25 μm thick). However, because it is thin, soft, and sensitive to deformation under force, the separator risks being pierced or otherwise damaged during the manufacturing process, which may cause the cell to short circuit. Also, because it has a low melting point, the separator risks shrinking or melting at the cell's high operating temperatures or locally overheating, which may cause the cell to release gas and swell. E. Roth, D. Doughty, and D. Pile, “Effects of separator breakdown on abuse response of 18650 Li-ion cells,” JPS 174(2), 579-583 (2007).

In another embodiment, a heat-absorbing (e.g., ceramic) coating may be applied to a component of the cell to stabilize the cell. However, known methods for applying such ceramic coatings, including chemical vapour deposition (CVD) methods and physical vapour deposition (PVD) methods (e.g., magnetron sputtering, pulsed laser deposition, e-beam evaporation), may be expensive, time consuming, and/or suffer from low deposition rates. Other known methods for applying the ceramic coatings require preparation of a wet slurry, including the ceramic coating material and a solvent. The solvent is intended to fluidize and suspend the ceramic coating material in the slurry. However, when the solvent is applied onto the battery component, the solvent also penetrates into underlying layers of the coated battery component and alters the structure of the underlying layers. After the slurry is applied onto the battery component, the battery component is subjected to high temperatures to remove the solvent and/or to achieve sintering, but these high temperatures may degrade the coated battery component and any adhesives contained therein.

### SUMMARY OF THE DISCLOSURE

The present disclosure relates to a non-aqueous electrochemical cell having a heat-resistant coating on at least one of a negative electrode, a positive electrode, and a separator, if provided. The heat-resistant coating may consume heat in the cell to stabilize the cell, act as an electrical insulator to prevent the cell from short circuiting, and increase the mechanical strength and compression resistance of the coated component.

According to an embodiment of the present disclosure, an electrochemical cell is provided including an anode having a conductive layer and an active layer applied to the conductive layer, and a cathode having a conductive layer and an active layer applied to the conductive layer. The cell also includes a heat-resistant coating on at least one of the active layer of the anode and the active layer of the cathode, the heat-resistant coating including a ceramic material, the heat-resistant coating being attached to at least one of the anode and the cathode due to plastic deformation of particles that form the heat-resistant coating which occurs during dry deposition.

According to another embodiment of the present disclosure, a method is provided for manufacturing an electrochemical cell. The method includes the steps of: providing an anode including a conductive layer and an active layer applied to the conductive layer; providing a cathode including a conductive layer and an active layer applied to the conductive layer; and forming a heat-resistant coating on at least one of the anode and the cathode by directing a powder-gas mixture at high speed toward at least one of the active layer of the anode and the active layer of the cathode.

According to yet another embodiment of the present disclosure, a method is provided for manufacturing an electrochemical cell, the cell including an anode having a conductive layer and an active layer, a cathode having a conductive layer and an active layer, and, optionally, a separator. The method includes the steps of: providing a dry ceramic powder; combining the dry ceramic powder with a carrier gas to produce a powder-gas mixture; and directing the powder-gas mixture at high speed toward at least one of the anode, the cathode, and the separator to form a heat-resistant coating on at least one of the anode, the cathode, and the separator.

According to still yet another embodiment of the present disclosure, a method is provided for manufacturing a solid state electrochemical cell. The method includes the steps of: directing a first powder-gas mixture toward a first substrate to form an active layer of an anode; directing a second powder-gas mixture toward a second substrate to form an active layer of a cathode; and directing a third powder-gas mixture toward at least one of the active layer of the anode and the active layer of the cathode to form a heat-resistant coating on at least one of the anode and the cathode.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 is a schematic view of a lithium-based electrochemical cell having a negative electrode, a positive electrode, and an optional separator;

FIG. 2 is a block diagram of an exemplary method for forming a heat-resistant coating;

FIG. 3 is a schematic view of an exemplary apparatus for forming a heat-resistant coating;

FIG. 4A is a photograph of a negative electrode before receiving a heat-resistant coating;

FIG. 4B is a photograph of the negative electrode of FIG. 4A with the heat-resistant coating applied according to Example 1;

FIG. 5 is a cross-sectional photograph of the negative electrode of FIG. 4B with the heat-resistant coating applied according to Example 1;

FIG. 6A is a photograph of a positive electrode before receiving a heat-resistant coating;

FIG. 6B is a photograph of the positive electrode of FIG. 6A with the heat-resistant coating applied according to Example 2;

FIG. 7 is a cross-sectional photograph of the positive electrode of FIG. 6B with the heat-resistant coating applied according to Example 2;

FIG. 8A is a photograph of a separator before receiving a heat-resistant coating;

FIG. 8B is a photograph of the separator of FIG. 8A with the heat-resistant coating applied according to Example 3;

FIGS. 9A and 9B are graphical discharge test results for an electrochemical cell manufactured according to Example 4, the cell lacking a polymeric separator; and

FIG. 10 is a cross-sectional photograph of a solid state electrochemical cell manufactured according to Example 5.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION OF THE DRAWINGS

The embodiments disclosed herein are not intended to be exhaustive or to limit the invention to the precise forms disclosed in the following detailed description. Rather, the embodiments are chosen and described so that others skilled in the art may utilize their teachings.

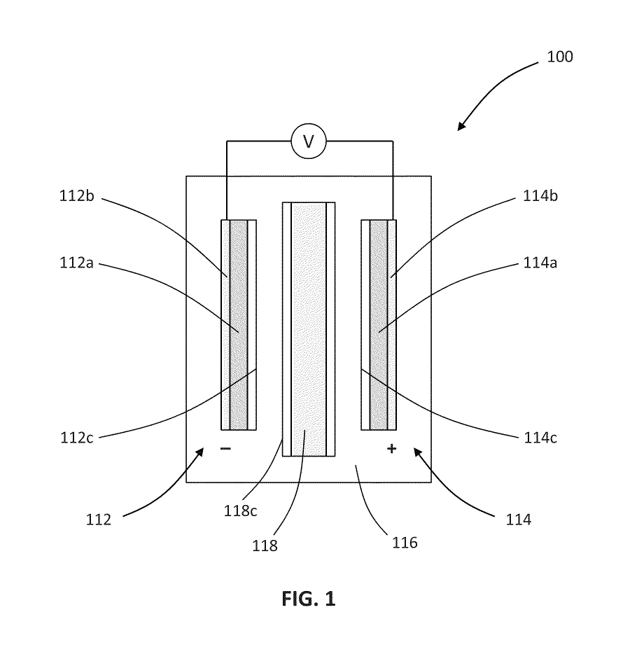

FIG. 1 provides a non-aqueous, lithium-based, electrochemical cell 100 which may be used in rechargeable and non-rechargeable batteries. Cell 100 may be used in a rechargeable battery of a hybrid electric vehicle (HEV) or an electric vehicle (EV), for example, serving as a power source that drives an electric motor of the vehicle. Cell 100 may also store and provide energy to other devices which receive power from batteries, such as the stationary energy storage market. Exemplary applications for the stationary energy storage market include providing power to a power grid, providing power as an uninterrupted power supply, and other loads which may utilize a stationary power source. In one embodiment, cell 100 may be implemented to provide an uninterrupted power supply for computing devices and other equipment in data centers. A controller of the data center or other load may switch from a main power source to an energy storage system of the present disclosure based on one or more characteristics of the power being received from the main power source or a lack of sufficient power from the main power source.

Cell 100 of FIG. 1 includes a negative electrode (or anode) 112 and a positive electrode (or cathode) 114. Between negative electrode 112 and positive electrode 114, cell 100 of FIG. 1 also contains an electrolyte 116 and, optionally, a separator 118. When discharging cell 100, lithium ions travel through electrolyte 116 from negative electrode 112 to positive electrode 114, with electrons flowing externally in the same direction from negative electrode 112 to positive electrode 114 and current flowing in the opposite direction from positive electrode 114 to negative electrode 112, according to conventional current flow terminology. When charging cell 100, an external power source forces reversal of the current flow from negative electrode 112 to positive electrode 114.

Negative electrode 112 of cell 100 illustratively includes a first layer 112a of an active material that interacts with lithium ions in electrolyte 116 and an underlying substrate or second layer 112b of a conductive material, as shown in FIG. 1. The first, active layer 112a may be applied to one or both sides of the second, conductive layer 112b using a suitable adhesive or binder or using mechanical fixation. It is also within the scope of the present disclosure to form negative electrode 112 by dry depositing active layer 112a onto conductive layer 112b, or vice versa, according to the method described below. The active material in the first layer 112a of negative electrode 112 should be capable of reversibly storing lithium species. Exemplary active materials for the first layer 112a of negative electrode 112 include lithium metal oxide (e.g., LiTiO), metal (e.g., Sn, Si), metal oxide (e.g., SnO, SiO), carbon (e.g., graphite, hard carbon, soft carbon, carbon fiber), and combinations thereof, for example. Exemplary conductive materials for the second layer 112b of negative electrode 112 include metals and metal alloys, such as copper, nickel, and stainless steel. The second, conductive layer 112b of negative electrode 112 may be in the form of a thin foil sheet or a mesh, for example.

Positive electrode 114 of cell 100 illustratively includes a first layer 114a of an active material that interacts with lithium ions in electrolyte 116 and an underlying substrate or second layer 114b of a conductive material. Like the first, active layer 112a of negative electrode 112, the first, active layer 114a of positive electrode 114 may be applied to one or both sides of the second, conductive layer 114b using a suitable adhesive or binder or using mechanical fixation, for example. It is also within the scope of the present disclosure to form positive electrode 114 by dry depositing active layer 114a onto conductive layer 114b, or vice versa, according to the method described below. The active material in the first layer 114a of positive electrode 114 should be capable of reversibly storing lithium species. Exemplary active materials for the first layer 114a of positive electrode 114 include lithiated transition metal oxides (e.g., LiMn₂O₄ (LMO), LiCoO₂ (LCO), LiNiO₂, LiFePO₄, LiNiCoMnO₂), combinations thereof, and their solid solutions, for example. The active materials may be combined with other metal oxides and dopant elements (e.g., titanium, magnesium, aluminum, boron, cobalt, nickel, manganese). Exemplary conductive materials for the second layer 114b of positive electrode 114 include metals and metal alloys, such as aluminum, titanium, and stainless steel. The second, conductive layer 114b of positive electrode 114 may be in the form of a thin foil sheet or a mesh, for example.

As shown in FIG. 1, negative electrode 112 and positive electrode 114 of cell 100 are plate-shaped structures. It is also within the scope of the present disclosure that negative electrode 112 and positive electrode 114 of cell 100 may be provided in other shapes or configurations, such as coiled configurations. It is further within the scope of the present disclosure that multiple negative electrodes 112 and positive electrodes 114 may be arranged together in a stacked configuration.

Electrolyte 116 of cell 100 illustratively includes a lithium salt dissolved in an organic, non-aqueous solvent. The solvent of electrolyte 116 may be in a liquid state, in a solid state, or in a gel form between the liquid and solid states. Suitable liquid solvents for use as electrolyte 116 include, for example, cyclic carbonates (e.g. propylene carbonate (PC), ethylene carbonate (EC)), alkyl carbonates, dialkyl carbonates (e.g., dimethyl carbonate (DMC), diethyl carbonate (DEC), ethyl methyl carbonate (EMC)), cyclic ethers, cyclic esters, glymes, lactones, formates, esters, sulfones, nitrates, oxazoladinones, ionic liquids, and combinations thereof. Suitable solid solvents for use as electrolyte 116 include, for example, polyethylene oxide (PEO), polyacrylonitrile (PAN), polymethylene-polyethylene oxide (MPEO), polyvinylidene fluoride (PVDF), polyphosphazenes (PPE), and combinations thereof. Suitable lithium salts for use in electrolyte 116 include, for example, LiPF₆, LiClO₄, LiSCN, LiAlCl₄, LiBF₄, LiN(CF₃SO₂)₂, LiCF₃SO₃, LiC(SO₂CF₃)₃, LiO₃SCF₂CF₃, LiC₆F₅SO₃, LiCF₃CO₂, LiAsF₆, LiSbF₆, and combinations thereof. Electrolyte 116 may comprise various combinations of the materials exemplified herein.

Separator 118 of cell 100, if provided, may be positioned between negative electrode 112 and positive electrode 114. Separator 118 is illustratively a porous or microporous, thin film membrane made from a polymeric material (e.g., polyolefin, polyethylene, polypropylene) or a ceramic material, for example. Separator 118 may act as an electrical insulator between negative electrode 112 and positive electrode 114 to prevent cell 100 from short circuiting.

Negative electrode 112, positive electrode 114, and/or separator 118, if provided, of cell 100 may include a heat-resistant coating. The heat-resistant coating may consume heat in cell 100 to stabilize cell 100, including during storage of cell 100 in high temperatures, during normal operation of cell 100 and high-current cycling, and in abuse conditions, for example. In particular, the heat-resistant coating may consume heat in cell 100 to stabilize temperature-sensitive components in cell 100, especially the temperature-sensitive separator 118, if provided. Also, the heat-resistant coating may act as an electrical insulator to prevent cell 100 from short circuiting. Furthermore, the heat-resistant coating may increase the mechanical strength and compression resistance of the coated battery component. The improved mechanical strength and compression resistance may be recognized even before cell 100 is used, such as when manufacturing, storing, and transporting cell 100. At the same time, the heat-resistant coating may be sufficiently porous or solid to allow lithium ions (Li⁺) to pass therethrough, depending on whether cell 100 uses a liquid state or a solid state electrolyte. The heat-resistant coating may also promote surface wetting by electrolyte 116.

In the illustrated embodiment of FIG. 1, negative electrode 112 includes heat-resistant coating 112c, positive electrode 114 includes heat-resistant coating 114c, and separator 118 includes heat-resistant coating 118c. Rather than coating all three of these components, as shown in FIG. 1, it is within the scope of the present disclosure to coat one of these components (e.g., negative electrode 112; positive electrode 114; or separator 118) or two of these components (e.g., negative electrode 112 and positive electrode 114; negative electrode 112 and separator 118; or positive electrode 114 and separator 118).

In the illustrated embodiment of FIG. 1, coatings 112c, 114c, are applied to one side of negative electrode 112 and positive electrode 114, respectively, and coating 118c is applied to both sides of separator 118. More specifically, in FIG. 1, coating 112c is applied on the right side of negative electrode 112 that faces positive electrode 114, and coating 114c is applied on the left side of positive electrode 114 that faces negative electrode 112. Rather than coating one side of negative electrode 112 and positive electrode 114, as shown in FIG. 1, it is also within the scope of the present disclosure to coat both sides of negative electrode 112 and positive electrode 114. This double-sided coating pattern may be used when cell 100 is provided in a stacked or coiled arrangement, for example.

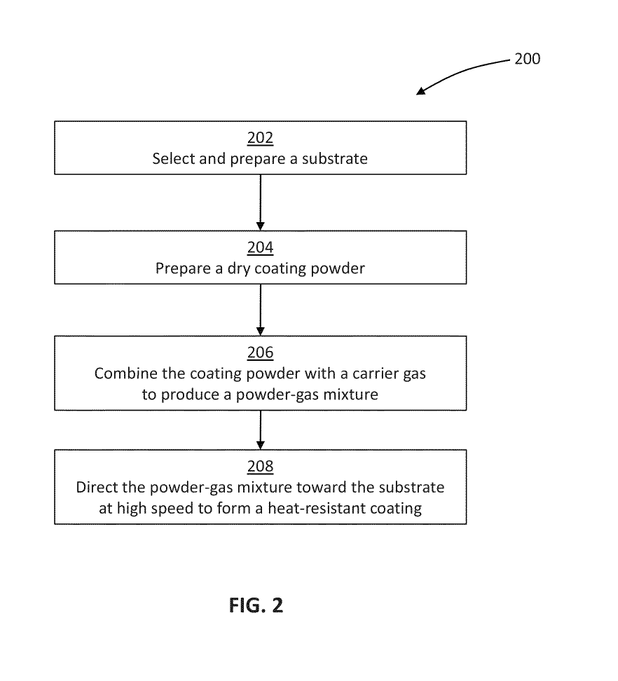

Referring next to FIG. 2, an exemplary method 200 is provided for preparing and dry-depositing the heat-resistant coating of the present disclosure. Method 200 is a dry-depositing method because the heat-resistant coating is applied in a dry, powdered form without the use of a wet, fluid solvent.

First, in step 202 of method 200, a substrate is selected and prepared for coating. The substrate may include negative electrode 112, positive electrode 114, and/or separator 118 of cell 100 (FIG. 1). The substrate may vary in size, shape, and material. If the selected substrate is negative electrode 112 or positive electrode 114, for example, the substrate will be in the form of a pre-coated metal sheet. If the selected substrate is separator 118, on the other hand, the substrate may be in the form of a polymeric film.

When the selected substrate is negative electrode 112 or positive electrode 114, the substrate should be pre-coated with its corresponding active layer 112a, 114a, before continuing through the remaining steps of method 200. Thus, in one embodiment, the preparing step 202 involves applying active layer 112a, 114a, onto conductive layer 112b, 114b, of the corresponding electrode 112, 114, using an aqueous carboxymethyl cellulose (CMC)/styrene butadiene rubber (SBR) binder slurry or an organic polyvinylidene fluoride (PVDF) binder slurry, for example, and allowing active layer 112a, 114a, to dry. In another embodiment, active layer 112a, 114a, may be dry deposited onto conductive layer 112b, 114b, of the corresponding electrode 112, 114, as discussed herein, using a suitable active powder. In yet another embodiment, conductive layer 112b, 114b, may be dry deposited onto active layer 112a, 114a, of the corresponding electrode 112, 114, as discussed herein, using a suitable metal conductive powder. In this manner, when the heat-resistant coating is eventually applied onto the selected electrode 112, 114, the heat-resistant coating will, more particularly, be applied onto active layer 112a, 114a, of the selected electrode 112, 114, as shown in FIG. 1.

The preparing step 202 may also involve cutting or otherwise shaping the selected substrate. In an exemplary embodiment of the present disclosure, the substrate may be cut from a bulk supply (e.g., a roll) into its final shape for use in cell 100 (FIG. 1). Shaping the substrate during the preparing step 202 will facilitate a batch coating process, which is discussed further below. It is also within the scope of the present disclosure that the substrate may remain in its bulk form to facilitate a continuous coating process.

In step 204 of method 200, a dry coating powder is prepared. The coating powder includes at least one heat-resistant ceramic material. The ceramic material may make up from about 50 wt. % up to about 100 wt. % of the total coating powder, and more specifically from about 60 wt. % up to about 100 wt. % of the total coating powder, and even more specifically from about 80 wt. % up to about 100 wt. % of the total coating powder.

In a first embodiment, the ceramic material of the dry coating powder is capable of conducting Li⁺ ions after wetting with an electrolyte in a liquid or gel state (e.g., electrolyte 116 of FIG. 1). Exemplary ceramic materials include inorganic oxides (e.g., CaO, Li₂O, SnO₂, ZrO₂, Al₂O₃, TiO₂, CeO₂, GeO₂, Y₂O₃, P₂O₅), inorganic carbides, inorganic nitrides, double-inorganic oxides (e.g., SrTiO₃, BaTiO₃), and chemically stable mixtures thereof. The ceramic material may also be phosphate-based, silicate-based, or sulphide-based.

In a second embodiment, the ceramic material of the dry coating powder is capable of conducting Li⁺ ions with or without wetting by an electrolyte in a liquid or gel state. In this second embodiment, the ceramic material itself serves as a solid state electrolyte. If desired, electrolyte 116 of FIG. 1 may be excluded from cell 100, with one or more of the coatings 112c, 114c, 118c serving as a solid state electrolyte. Exemplary ceramic materials suitable for use as solid state electrolytes include super-ionic conductor ceramics, including β-LiAlSiO₄, Li-β-Al₂O₃, Li₂S—P₂S₅—SiS₂ glasses, oxide-based glasses (e.g., Li₂O—Cr₂O₃—GeO₂—P₂O₅), sodium super-ionic conductor (NASICON)-type ceramics with lithium (e.g., Li_{1+x+y}AlₓTi₂₋ₓSi_{y}P_{3-y}O₁₂), and other super-ionic conductor ceramics (e.g., LiZrTiAl(PO₄)₃, LiLaTiO (LLT), lithium aluminum germanium phosphates). These ceramic materials may also be incorporated into the underlying active layer 112a, 114a, of the selected electrode 112, 114, at concentrations from about 0 wt. % up to about 40 wt. %, and more specifically from about 15 wt. % up to about 30 wt. %.

The ceramic material may include agglomerates of primary particles. The particle size of the primary particles may be from about 0.05 μm up to about 5.0 μm. More specifically, the particle size of the primary particles may be as low as about 0.05 μm, 0.1 μm, 0.5 μm, 1.0 μm, 1.5 μm, or 2.0 μm and as high as about 3.0 μm, 3.5 μm, 4.0 μm, 4.5 μm, and 5.0 μm, or within any range defined between any pair of the foregoing values, for example. The particle size of the agglomerates may be from about 5.0 μm up to about 10.0 μm. More specifically, the particle size of the agglomerates may be as low as about 5.0 μm, 6.0 μm, or 7.0 μm and as high as about 8.0 μm, 9.0 μm, or 10.0 μm, or within any range defined between any pair of the foregoing values, for example.

Optionally, the coating powder may also include a binder material. The binder material may make up 0 wt. % to 15 wt. % of the total coating powder. Exemplary binder materials include polymers, such as polyethylene, polypropylene, polyvinylidene fluoride (PVDF), polyphenylene sulfide (PPS), and polyoxyethylene methacrylate (POEM), other ductile materials, and mixtures thereof. The particle size of the binder material may be from about 0.5 μm up to about 20.0 μm. More specifically, the particle size of the binder material may be as low as about 0.5 μm, 1.0 μm, 1.5 μm, 2.0 μm, or 2.5 μm and as high as about 17.0 μm, 17.5 μm, 18.0 μm, 19.5 μm, and 20.0 μm, or within any range defined between any pair of the foregoing values, for example.

Optionally, the coating powder may further include one or more lithium salts. The lithium salt may make up 0 wt. % to 50 wt. % of the total coating powder. An exemplary lithium salt includes, for example, lithium perchlorate (LiClO₄).

Optionally, the coating powder may further include a foam former. During deposition of the coating powder, the foam former should partially or fully decompose into a gas, leaving behind pores in the coating. The foam former may make up 0 wt. % to 30 wt. % of the total coating powder. Exemplary foam formers include, for example, lithium carbonate (Li₂CO₃), ammonium carbonate ((NH₄)₂CO₃), and mixtures thereof.

The preparing step 204 may involve pulverizing, milling, grinding, or otherwise agitating the coating powder to obtain a substantially uniform mixture. When the coating powder includes more than one ingredient, the agitating step may promote even mixing of the various ingredients. The agitating step may also alter the particle size of the various ingredients, if desired.

In step 206 of method 200, the coating powder encounters a high-pressure and high-temperature carrier gas to produce a powder-gas mixture. The carrier gas may be dry, oxygen-containing air. Even at the high temperatures used in this process, the short exposure times may prevent the oxygen in the air from interacting or interfering with the coating powder and the underlying active material, if applicable. However, it is also within the scope of the present disclosure that the carrier gas may be an oxygen-free, inert gas (e.g., nitrogen, helium, a nitrogen-helium mixture, argon).

The temperature of the carrier gas may be from about 100° C. up to about 450° C. More specifically, the temperature of the carrier gas may be as low as about 100° C., 150° C., 200° C., or 250° C. and as high as about 300° C., 350° C., 400° C., or 450° C., or within any range defined between any pair of the foregoing values, for example. If the powder includes a polymeric binder material, the temperature of the carrier gas should be close to the melting point of the binder material. For example, if the powder includes a PVDF binder material, which has a melting point of about 177° C., the temperature of the carrier gas may be about 170° C., 180° C., 190° C., or 200° C., for example. At these temperatures, the binder material will spread substantially uniformly around and on top of the ceramic material. However, the temperature of the carrier gas should be substantially less than the melting point of the heat-resistant ceramic material in the powder. For example, if the powder includes Al₂O₃ as the heat-resistant ceramic material, which has a melting point above 2000° C., the temperature of the carrier gas may be 1500° C. or more below the melting point of the ceramic material.

The pressure of the carrier gas may be from about 10 atm (1013 kPA) up to about 40 atm (4053 kPA). More specifically, the pressure of the carrier gas may be as low as about 10 atm (1013 kPA), 15 atm (1520 kPA), 20 atm (2027 kPA), or 25 atm (2533 kPA) and as high as about 30 atm (3040 kPA), 35 atm (3546 kPA), or 40 atm (4053 kPA), or within any range defined between any pair of the foregoing values, for example.

In step 208 of method 200, the powder-gas mixture is directed through a nozzle and toward the substrate at high speed, potentially a supersonic speed, to form a heat-resistant coating on the substrate. The high speed may be from about 100 m/s up to about 700 m/s, or more. More specifically, the high speed may be as low as about 100 m/s, 200 m/s, or 300 m/s and as high as about 500 m/s, 600 m/s, or 700 m/s, or more, or within any range defined between any pair of the foregoing values, for example.

The powder particles in the coating step 208 have enough kinetic energy that, upon contact with the substrate, the particles may embed in the substrate and undergo plastic deformation. Plastic deformation may involve the powder particles permanently changing shape when colliding into the substrate with high force. Plastic deformation may be achieved without melting the ceramic powder particles, which would require extremely high temperatures (e.g., 2000° C. or more) that could damage the substrate. As a result of plastic deformation, the particles (e.g., the ceramic particles and the binder particles) firmly attach to the substrate and to each other to form a suitably porous or solid, heat-resistant coating on the substrate that is substantially uniform in thickness and particle distribution. The speed of the powder-gas mixture, and the resulting kinetic energy of the powder particles, may be regulated by varying the structure of the nozzle, the temperature of the carrier gas, and/or the pressure of the carrier gas. For example, as the temperature of the carrier gas increases, the pressure of the carrier gas may decrease and still maintain a desired delivery speed. The speed of the powder-gas mixture may vary depending on, for example, the nature, shape, and composition of the powder and the structure and composition of the underlying substrate.

If each substrate is cut to its final shape during the preparing step 202, as discussed above, the coating step 208 may be a batch process, where each substrate is coated individually or in a group. Although a continuous coating process is also workable, the batch coating process offers several advantages. First, because the substrate is already in its final shape, the heat-resistant coating may be applied to precise, predetermined areas of the final substrate without substantial waste. Second, the heat-resistant coating may be applied around the edges of the substrate to eliminate any sharp edges and surface irregularities from the prior shaping process. Finally, further shaping of the hard, heat-resistant coating may be avoided.

Returning to FIG. 1, the heat-resistant coating 112c, 114c, 118c, should be sufficiently solid to avoid a short circuit in cell 100 while being sufficiently porous or solid to allow Li⁺ ions to pass therethrough, depending on whether cell 100 includes a liquid state or a solid state electrolyte. When cell 100 includes a non-aqueous liquid state electrolyte (e.g., electrolyte 116 of FIG. 1), an exemplary coating 112c, 114c, 118c, for a liquid state cell may have a porosity from about 30% up to about 80%. More specifically, an exemplary coating 112c, 114c, 118c, may have a porosity as low as about 30%, 40%, or 50% and as high as about 60%, 70%, or 80%, or within any range defined between any pair of the foregoing values, for example. When cell 100 includes a solid state electrolyte, on the other hand, an exemplary coating 112c, 114c, 118c, may be as solid as possible, with a porosity from about 0% up to about 30%. More specifically, an exemplary coating 112c, 114c, 118c, for a solid state cell may have a porosity as low as about 0%, 5%, or 10% and as high as about 15%, 20%, 25%, or 30%, or within any range defined between any pair of the foregoing values, for example. The porosity of coating 112c, 114c, 118c, may be regulated by varying the size, shape, and density of the powder particles, for example. Also, the porosity of coating 112c, 114c, 118c, may be regulated by including or excluding a foam former from the coating powder and varying the amount of the foam former present in the coating powder, as discussed above. Additionally, the porosity of coating 112c, 114c, 118c, may be regulated by varying the deposition conditions, such as the temperature and pressure of the carrier gas in the powder-gas mixture.

Also, the heat-resistant coating 112c, 114c, 118c, should be sufficiently thick to avoid a short circuit in cell 100 while being sufficiently thin to allow Li⁺ ions to pass therethrough with minimal resistance and to decrease the amount of side materials in cell 100. An exemplary coating 112c, 114c, 118c, may have a thickness from about 1 μm up to about 30 μm. More specifically, an exemplary coating 112c, 114c, 118c, may be as thin as about 1 μm, 5 μm, or 10 μm and as thick as about 15 μm, 20 μm, 25 μm, or 30 μm, or within any range defined between any pair of the foregoing values. For example, an exemplary coating 112c, 114c, 118c, may be as thin as about 1 μm and as thick as about 15 μm. The thickness of coating 112c, 114c, 118c, may be regulated by varying the deposition amount, the deposition time, and the size of the deposited powder particles, for example.

If any coating 112c, 114c, 118c, is relatively thin, separator 118 (whether coated or uncoated itself) may be required in cell 100 to avoid a short circuit. On the other hand, separator 118 may be excluded from cell 100 altogether by providing one or more relatively thick coatings 112c, 114c, on electrodes 112, 114. In this embodiment, coating 112c, 114c, on electrode 112, 114, may behave as a separator, preventing direct electrical contact between electrodes 112, 114.

Coating 112c, 114c, should be as thin as possible. Therefore, when coating 112c, 114c, is applied to electrode 112, 114, in particular, the thickness of the underlying active layer 112a, 112b, may exceed the thickness of the thin coating 112c, 114c. In one particular example, the underlying active layer 112a, 112b, has a thickness of about 60 μm, while coating 112c, 114c, has a thickness of about 15 μm, making active layer 112a, 112b, about 4 times as thick as coating 112c, 114c. In another example, the underlying active layer 112a, 112b, is even thicker than 60 μm, such as about 100 μm or 200 μm, making active layer 112a, 112b, substantially thicker than coating 112c, 114c.

Also, when coating 112c, 114c, is applied to electrode 112, 114, the ceramic particles in coating 112c, 114c, may be smaller than the active particles in the underlying active layer 112a, 114a, of electrode 112, 114. In one particular example, the ceramic particles in coating 112c, 114c are about 1 μm in size, while the active particles in active layer 112a, 114a, are about 15 μm to 20 μm in size, making the active particles in active layer 112a, 112b, about 15 to 20 times as large as the ceramic particles in coating 112c, 114c.

Furthermore, when coating 112c, 114c, is applied to electrode 112, 114, the ceramic material in coating 112c, 114c, may differ in chemical make-up from the active material in the underlying active layer 112a, 114a, of electrode 112, 114. In one particular negative electrode 112, the ceramic material in coating 112c is Al₂O₃ and the active material in active layer 112a is graphite or LiTiO. In one particular positive electrode 114, the ceramic material in coating 114c is Al₂O₃ and the active material in active layer 114a is LiCoO₂.

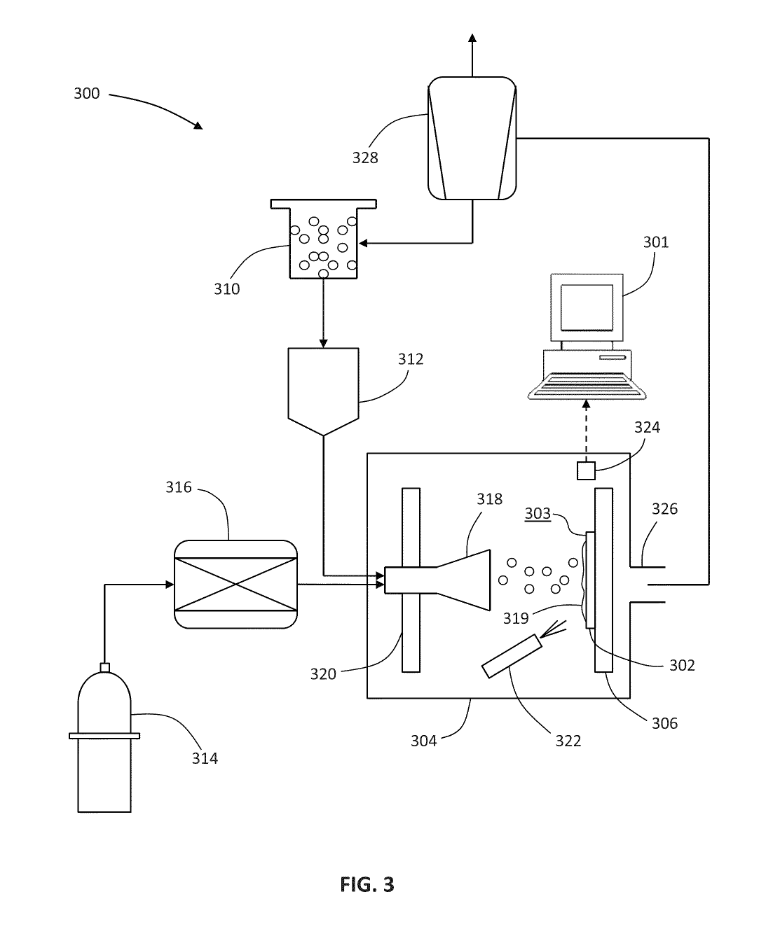

Referring next to FIG. 3, an exemplary apparatus 300 is provided for performing method 200 (FIG. 2) to prepare and apply the heat-resistant coating of the present disclosure. Apparatus 300 illustratively includes controller 301, which may be a general purpose computer. Controller 301 may access certain process parameters from memory and/or from a user input (e.g., a keyboard). In an exemplary embodiment of the present disclosure, the user inputs information regarding the substrate and the desired characteristics of the heat-resistant coating, and the controller 301 automatically generates the process control parameters required to produce the desired heat-resistant coating.

The first step 202 of method 200 (FIG. 2) involves selecting and preparing a substrate. The selected substrate 302 is shown in FIG. 3 inside housing 304 of apparatus 300. Specifically, the selected substrate 302 is shown mounted onto support 306 inside housing 304 of apparatus. Support 306 is provided to hold substrate 302 tightly in place during the coating process. The illustrated support 306 is shaped as a flat plate to receive a similarly shaped substrate 302. If substrate 302 were provided on a continuous roll, instead of as an individual plate, support 306 could be shaped as a roller to hold and unroll substrate 302. Substrate 302 may include negative electrode 112, positive electrode 114, and/or separator 118 of cell 100 (FIG. 1). As discussed above, the selected substrate 302—negative electrode 112, positive electrode 114, or separator 118—is tightly supported by support 306.

The second step 204 of method 200 (FIG. 2) involves preparing a dry coating powder. Apparatus 300 of FIG. 3 illustratively includes mill 310 (e.g., a ball mill, a jet mill) to hold, pulverize, and mix the coating powder ingredients. Apparatus 300 also includes feeder 312 to deliver a measured amount of the coating powder. The operation of mill 310 and feeder 312 may be controlled by controller 301.

The third step 206 of method 200 (FIG. 2) involves injecting the coating powder into a high-pressure and high-temperature carrier gas to produce a powder-gas mixture. Apparatus 300 of FIG. 3 illustratively includes pressure tank 314 for supplying the pressurized carrier gas and heater 316 for heating the pressurized carrier gas. The operation of pressure tank 314 and heater 316 may be controlled by controller 301. The carrier gas from tank 314 and heater 316 encounters the coating powder from mill 310 and feeder 312 in nozzle 318 to form the powder-gas mixture.

The fourth step 208 of method 200 (FIG. 2) involves directing the powder-gas mixture from nozzle 318 toward substrate 302 at high speed to form a heat-resistant coating 319 on substrate 302. Nozzle 318 of FIG. 3 is illustratively in the form of a de Laval nozzle. Nozzle 318 is mounted on a robotic arm 320 for moving nozzle 318 in housing 304 relative to substrate 302. For example, as nozzle 318 sprays the powder-gas mixture toward substrate 302, arm 320 may move nozzle 318 side to side and up and down in housing 304 across the outer surface 303 of substrate 302. The operation of nozzle 318 and arm 320 may be controlled by controller 301.

Apparatus 300 may also include heater 322, which may be in the form of a laser heater or another suitable heater. While the powder-gas mixture is being sprayed onto substrate 302, heater 322 may be activated to locally heat the coated area of substrate 302 to improve adhesion of the heat-resistant coating 319. It is also within the scope of the present disclosure to operate heater 322 before spraying the powder-gas mixture onto substrate 302 and/or after spraying the powder-gas mixture onto substrate 302. The operation of heater 322 may be controlled by controller 301.

Apparatus 300 may further include a feedback sensor 324 to monitor the coating process. For example, sensor 324 may monitor a thickness and/or a density of the heat-resistant coating 319. In one embodiment, sensor 324 is an optical sensor capable of measuring the changing thickness of coating 319 and having a suitable sensitivity (e.g., about 0.5 μm or less). In another embodiment, sensor 324 is a force or load sensor capable of measuring the changing weight of substrate 302 with coating 319 and having a suitable sensitivity (e.g., 0.1 mg/cm²). Sensor 324 communicates the sensed data to controller 301, as shown in FIG. 3, and controller 301 uses the sensed data to control the coating process. If, for example, sensor 324 communicates a sensed thickness equal to the desired thickness of the heat-resistant coating 319, controller 301 may turn off nozzle 318 and turn on heater 322 to finish the coating process.

Apparatus 300 may still further include an exhaust 326 and a solid-gas separator 328. An exemplary separator 328 includes a cyclone. Excess powder-gas mixture that is not applied to substrate 302 may travel through exhaust 326 to separator 328. The separated coating powder may be returned to mill 310 for reuse, and the separated carrier gas may be vented from the system or returned to pressure tank 314 for reuse.

Although apparatus 300 (FIG. 3) is described herein for performing the dry coating method 200 (FIG. 2), other equipment capable of accelerating dry particles through a nozzle toward a surface that is to be coated may be used to perform the dry coating method 200.

### EXAMPLES

The following examples are meant to illustrate, but in no way to limit, the claimed invention.

### 1. Example 1

### Deposition of Heat-Resistant Coating onto a Negative Electrode

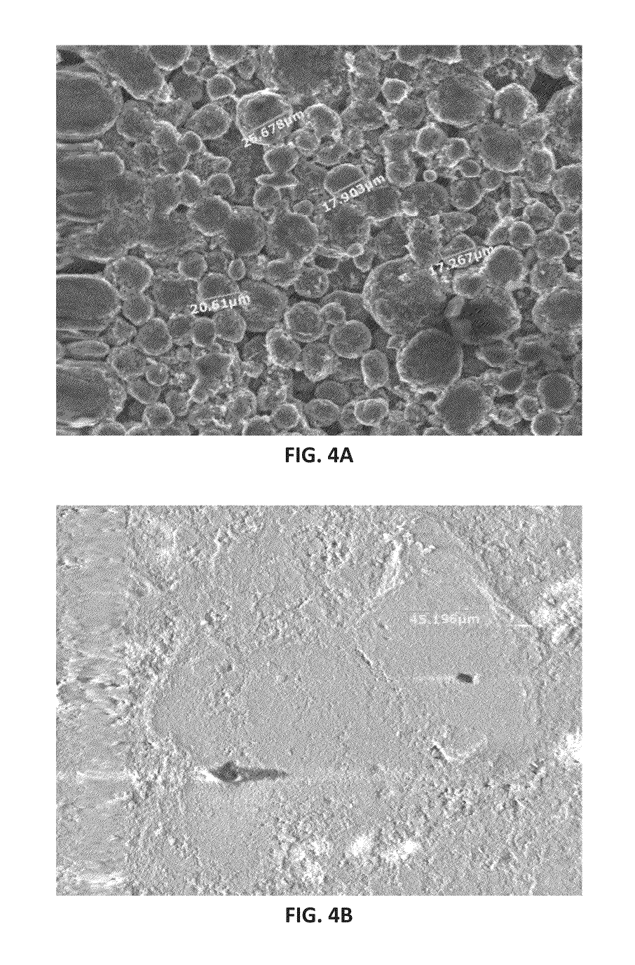

A negative electrode was manufactured by applying an active slurry onto an underlying conductive layer. The active slurry comprised 7 wt. % PVDF binder, 85 wt. % graphite active material, and 8 wt. % carbon black additive. Graphite particles in the active slurry were 15 μm to 20 μm in size. The conductive layer comprised a 20 μm thick copper foil sheet. The active slurry was applied to both sides of the copper foil sheet at a thickness of about 60 μm per side and allowed to dry. A SEM photograph of the outer surface of the resulting active layer is shown in FIG. 4A at 460× magnification.

A powder-gas mixture was sprayed on top of one of the previously-formed active layers to form a heat-resistant coating on one side of the negative electrode. The powder in the powder-gas mixture comprised 90 wt. % α-Al₂O₃ ceramic powder with an average particle size of 1 μm, and 10 wt. % PVDF binder powder with an average particle size of 2 μm. The powder particles were ground and mixed before encountering a carrier gas at a temperature of 250° C. and a pressure of 30 atm (3040 kPa).

The heat-resistant coating was applied to one side of the negative electrode at a density of about 7 mg/cm² and a thickness of about 15 μm. A SEM photograph of the outer surface of the heat-resistant coating is shown in FIG. 4B. Before receiving the heat-resistant coating (FIG. 4A), the outer surface of the negative electrode was rough and uneven. After receiving the heat-resistant coating (FIG. 4B), the outer surface of the coated negative electrode was smooth, but still porous.

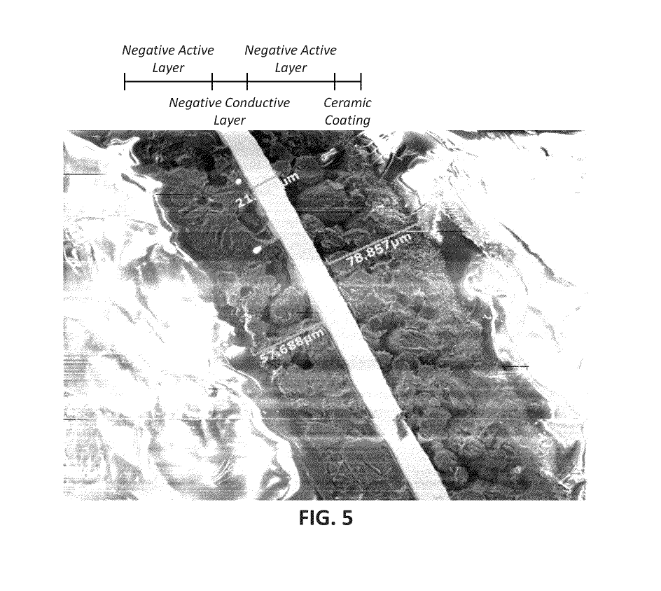

A cross-sectional view of the coated negative electrode is shown in FIG. 5, including a central copper foil conductive layer, two opposing graphite active layers, and one heat-resistant ceramic layer. The graphite active layer with the heat-resistant ceramic coating appears the same as the exposed graphite active layer that lacks a heat-resistant ceramic coating, which evidences that the heat-resistant ceramic coating was applied without disturbing, deforming, or otherwise changing the underlying graphite active layer.

The heat-resistant ceramic coating exhibited strong adhesion to the underlying graphite active layer. Attempts to remove the heat-resistant coating destroyed the negative electrode. The heat-resistant coating also exhibited strong electrical resistance. When a conductor was pressed against the heat-resistant coating, the electrical resistance measured between the conductor and the dry negative electrode exceeded 200 MOhm. The heat-resistant coating also exhibited acceptable porosity for electrolyte wetting.

When the coated outer surface of the negative electrode was subjected to chemical spectral analysis, carbon from the active layer was absent from the chemical spectrum, which evidences full coverage of the active layer by the heat-resistant ceramic layer.

### 2. Example 2

### Deposition of Heat-Resistant Coating onto a Positive Electrode

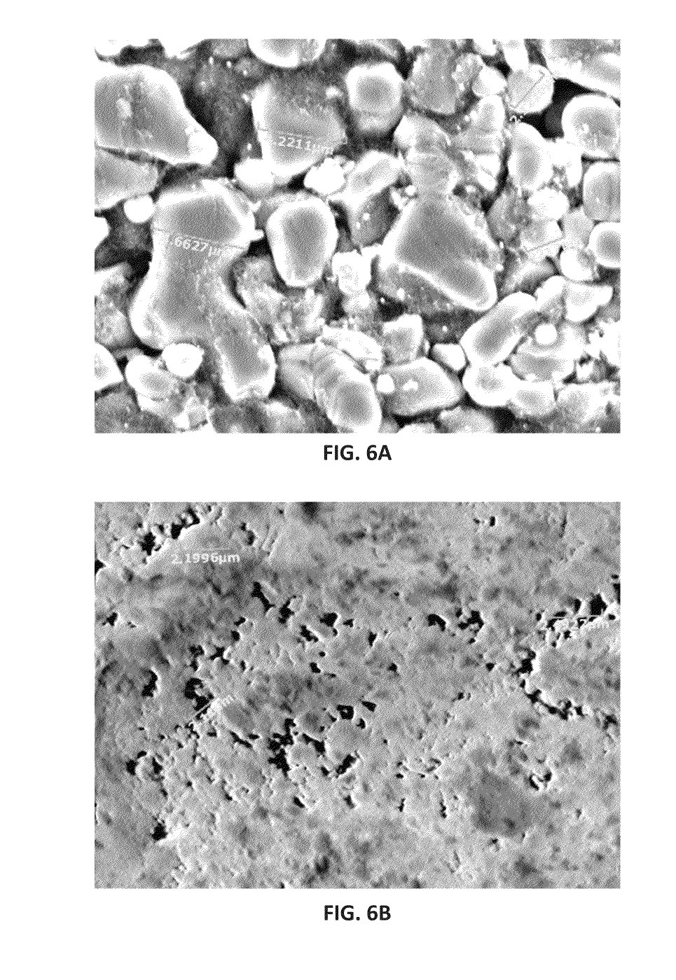

A positive electrode was manufactured by applying an active slurry onto an underlying conductive layer. The active slurry comprised 4 wt. % PVDF binder, 87 wt. % LiCoO₂ powder, 5 wt. % graphite additive, and 4 wt. % carbon black additive. LiCoO₂ powder particles in the active slurry were about 2 μm in size. The conductive layer comprised a 20 μm thick aluminum foil sheet. The active slurry was applied to both sides of the copper foil sheet at a thickness of about 120 μm per side and allowed to dry. A SEM photograph of the outer surface of the resulting active layer is shown in FIG. 6A at 5000× magnification. Compared to the negative active layer of FIG. 4A, the positive active layer of FIG. 6A was more smooth.

A powder-gas mixture was sprayed on top of one of the previously-formed active layers to form a heat-resistant coating on one side of the positive electrode. The powder in the powder-gas mixture comprised 90 wt. % Li-β-Al₂O₃ ceramic powder with an average particle size of 0.5 μm, and 10 wt. % PVDF binder powder with an average particle size of 2 μm. The powder particles were ground and mixed before encountering a carrier gas at a temperature of 200° C. and a pressure of 35 atm (3546 kPa).

The heat-resistant coating was applied to one side of the positive electrode at a density of about 2 mg/cm² and a thickness between about 4 μm and 6 μm, specifically about 5 μm. A SEM photograph of the outer surface of the heat-resistant coating is shown in FIG. 6B. The heat resistant coating (FIG. 6B) made the coated outer surface of the positive electrode more smooth (compared to FIG. 6A), but still porous.

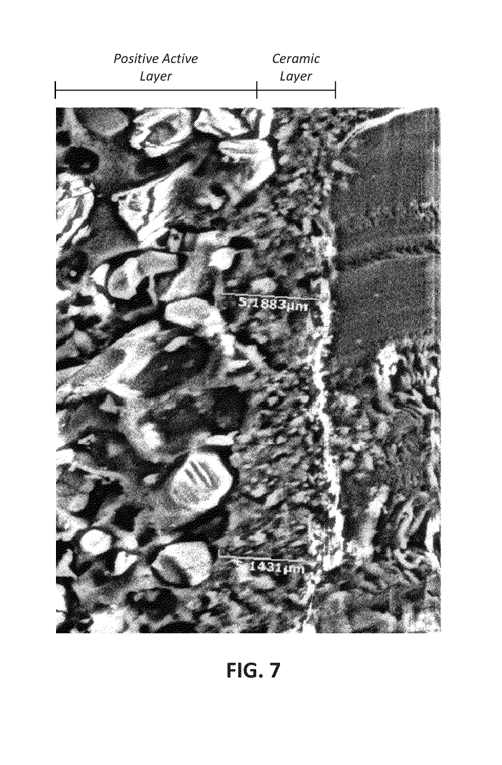

A cross-sectional view of the coated positive electrode is shown in FIG. 7, including a LiCoO₂ active layer and an outer heat-resistant ceramic layer. The heat-resistant ceramic layer of FIG. 7 is porous and substantially uniform in thickness.

The thin heat-resistant coating exhibited strong electrical resistance. When a conductor was pressed against the heat-resistant coating, the electrical resistance measured between the conductor and the dry positive electrode exceeded 200 MOhm.

When the coated outer surface of the positive electrode was subjected to chemical spectral analysis, cobalt (Co) from the active layer was absent from the chemical spectrum, which evidences full coverage of the active layer by the heat-resistant ceramic layer.

### 3. Example 3

### Deposition of Heat-Resistant Coating onto a Polymeric Separator

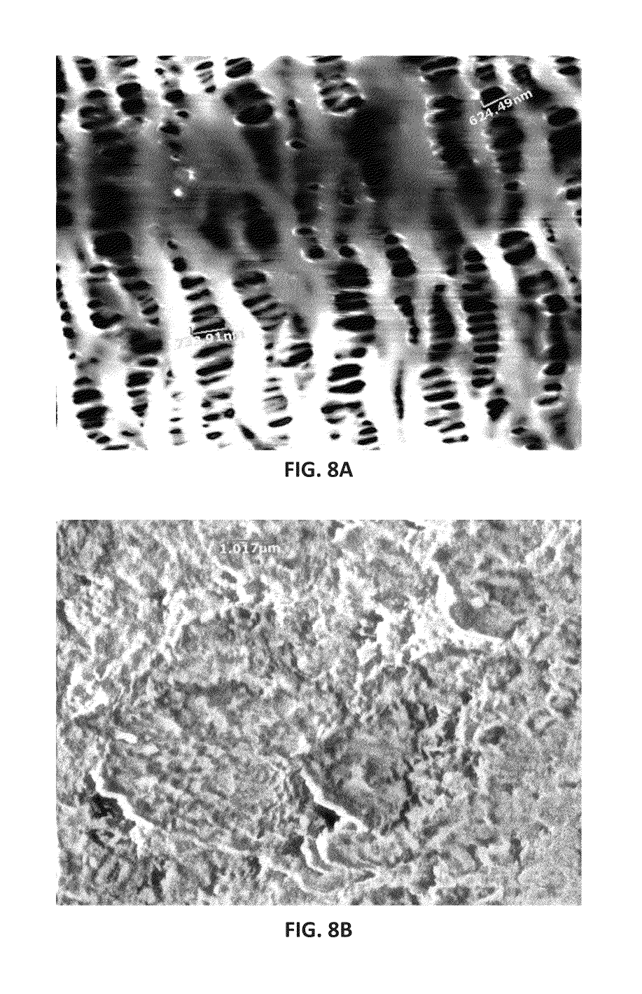

An enhanced separator was manufactured by applying a heat-resistant ceramic coating onto an underlying polyethylene separator. The underlying polyethylene separator had a thickness of about 20 μm and a porosity of about 45%. A SEM photograph of the outer surface of the polyethylene separator is shown in FIG. 8A.

A powder-gas mixture was sprayed on top of the polyethylene separator to form a heat-resistant coating on the polyethylene separator. The powder in the powder-gas mixture comprised 95 wt. % α-Al₂O₃ ceramic powder with an average particle size of 0.1 μm, and 5 wt. % PVDF binder powder with an average particle size of 2 μm. The powder particles were ground and mixed before encountering a carrier gas at a temperature of 120° C. and a pressure of 20 atm (2027 kPa).

The heat-resistant coating was applied to the polyethylene separator at a density of about 1 mg/cm² and a thickness of about 3 μm. A SEM photograph of the outer surface of the heat-resistant coating is shown in FIG. 8B. The heat resistant coating (FIG. 8B) made the outer surface of the coated polyethylene separator more smooth compared to FIG. 8A, but still porous.

### 4. Example 4

### Assembling an Electrochemical Cell without a Polymeric Separator

An electrochemical coin cell was assembled with a negative electrode, a positive electrode, and an electrolyte, but without a polyethylene separator. The negative and positive electrodes were 2 cm² in size. The negative electrode was in the form of a lithium foil sheet. The positive electrode was manufactured according to Example 2, except that the positive electrode included a 15 μm thick (not 5 μm thick) heat-resistant ceramic coating. The electrolyte was 1.2 M LiPF₆ in EC/EMC.

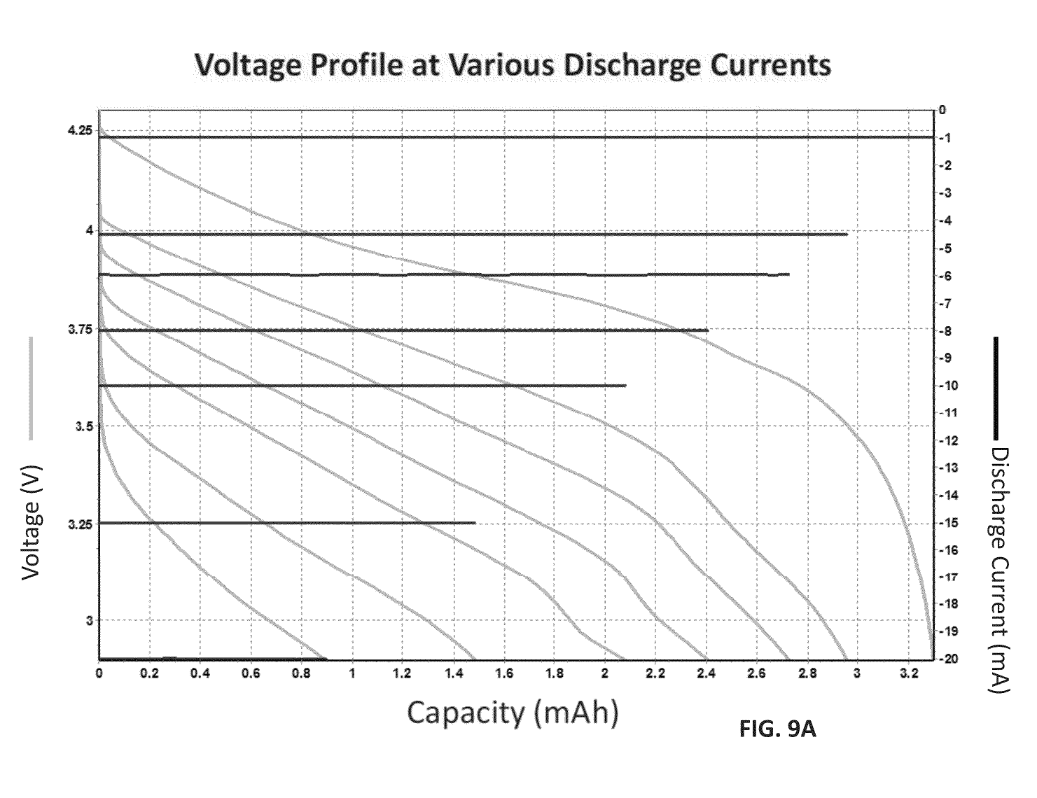

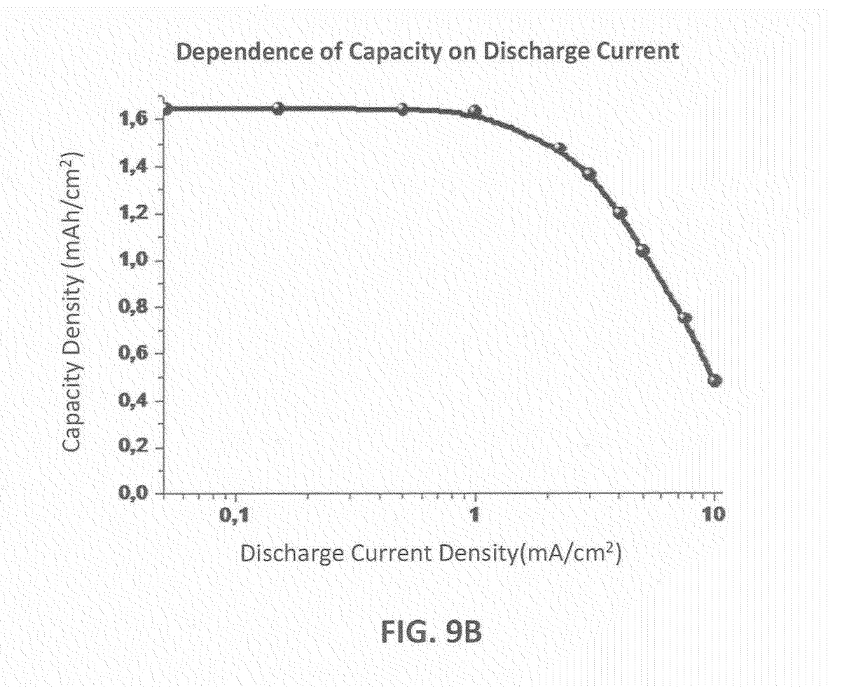

The coin cell was subjected to discharge testing at various discharge currents, the results of which are presented in FIGS. 9A and 9B. These results, which were achieved without a polyethylene separator, were comparable to those achieved with a polyethylene separator. These results evidence that the heat-resistant ceramic coating on the positive electrode had suitable porosity to transfer Li⁺ ions, suitable electrical resistance to avoid a short circuit, and suitable uniformity.

Similar coin cells were also subjected to high-temperature storage at 120° C. for several hours. Cells having a heat-resistant ceramic coating on the positive electrode instead of a polyethylene separator maintained workability after the high-temperature storage. However, cells having a traditional polyethylene separator instead of the heat-resistant ceramic coating of the present disclosure deteriorated due to heat shrinking and melting of the separator. These results evidence that providing a heat-resistant ceramic coating on an electrode and removing the polyethylene separator may improve mechanical and thermal properties of the cell.

### 5. Example 5

### Assembling a Solid State Electrochemical Cell

A solid state electrochemical cell was assembled with a negative electrode and a positive electrode, but without a liquid state electrolyte and a polyethylene separator. In this embodiment, the heat-resistant ceramic coating serves as both a Li⁺ conducting solid state electrolyte and a separator.

The positive electrode included an active layer that was dry-deposited onto an underlying conductive layer according to the method described herein. The active powder used to form the active layer comprised 5 wt. % PVDF binder, 60 wt. % LiCoO₂, 5 wt. % binder electro-conductive carbon black additive, and 30 wt. % Li₂O—Cr₂O₃—GeO₂—P₂O₅ glass, which serves as a Li⁺ conductive solid electrolyte in the active layer. Additionally, the positive electrode included a heat-resistant ceramic coating that was dry-deposited on top of the active layer according to Example 2, except that the heat-resistant coating was about 20 μm thick (not 5 μm thick as in Example 2) and contained Li₂O—Cr₂O₃—GeO₂—P₂O₅ glass (not Li-β-Al₂O₃ as in Example 2). As discussed above, this Li₂O—Cr₂O₃—GeO₂—P₂O₅ glass coating also served as a solid state electrolyte and a separator.

The negative electrode was formed on top of the heat-resistant coating, which had already been applied to the positive electrode. First, an active layer of the negative electrode was dry-deposited onto the underlying heat-resistant coating according to the method described herein. The active powder used to form the active layer comprised 5 wt. % PVDF binder, 60 wt. % LiTiO, 5 wt. % binder electro-conductive carbon black additive, and 30 wt. % Li₂O—Cr₂O₃—GeO₂—P₂O₅ glass, which serves as a Li⁺ conductive solid electrolyte in the active layer. Second, a conductive layer of the negative electrode was dry-deposited onto the underlying active layer according to the method described herein using a metal conductive powder.

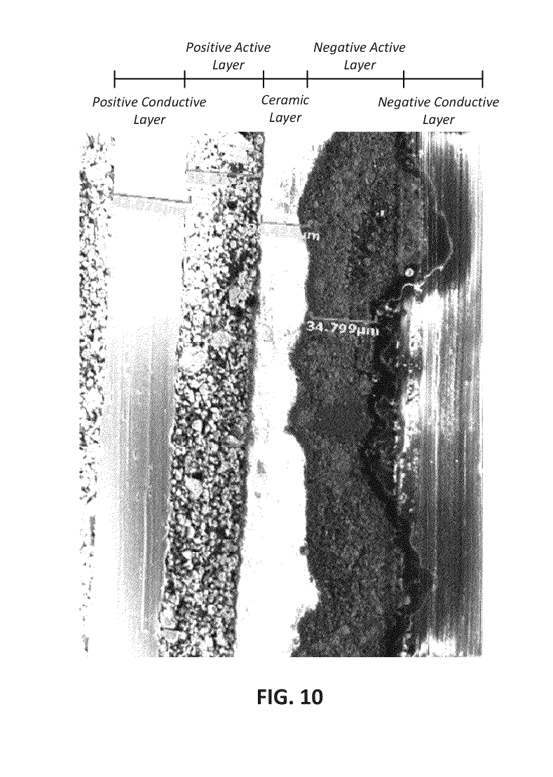

A partial cross-sectional view of the solid state cell is shown in FIG. 10. The cell was built layer-by-layer, starting with the positive conductive layer on bottom (left side of FIG. 10) and ending with the negative conductive layer on top (right side of FIG. 10).

The cell was subjected to electrochemical testing and exhibited good performance with voltages plateauing between 2.2 V and 2.4 V and at low current densities. At ambient temperatures, current densities reached 0.2 mA/cm². The larger current densities were limited by interface resistance of the used solid state electrolyte.

The solid state cell was also subjected to high-temperature testing by being heated to 120° C. multiple times, and the cell maintained workability after the high-temperature testing.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An electrochemical cell comprising:
an anode comprising:
a conductive layer; and
an active layer applied to the conductive layer;
a cathode comprising:
a conductive layer; and
an active layer applied to the conductive layer; and
a heat-resistant coating on at least one of the active layer of the anode and the active layer of the cathode, the heat-resistant coating comprising a ceramic material, the heat-resistant coating being attached to at least one of the anode and the cathode due to plastic deformation of particles that form the heat-resistant coating which occurs during dry deposition.

2. The electrochemical cell of claim 1, wherein the particles in the heat-resistant coating are delivered at a high speed toward at least one of the active layer of the anode and the active layer of the cathode to increase the kinetic energy of the particles, the particles undergoing plastic deformation and attaching to at least one of the active layer of the anode and the active layer of the cathode when encountering at least one of the active layer of the anode and the active layer of the cathode.

3. The electrochemical cell of claim 1, wherein the ceramic material includes at least one of an inorganic oxide, an inorganic carbide, an inorganic nitride, and a double-inorganic oxide, the electrochemical cell further comprising a non-aqueous liquid electrolyte in communication with the anode and the cathode, the ceramic material being capable of conducting lithium ions between the anode and the cathode after wetting with the liquid electrolyte.

4. The electrochemical cell of claim 3, wherein the ceramic material includes at least one of CaO, Li₂O, SnO₂, ZrO₂, Al₂O₃, TiO₂, CeO₂, GeO₂, Y₂O₃, P₂O₅, SrTiO₃, and BaTiO₃.

5. The electrochemical cell of claim 1, wherein the ceramic material serves as a solid state electrolyte that is capable of conducting lithium ions between the anode and the cathode.

6. The electrochemical cell of claim 5, wherein the ceramic material includes at least one super-ionic conductor ceramic selected from the group consisting of β-LiAlSiO₄, Li-β-Al₂O₃, Li₂S—P₂S₅—SiS₂ glasses, Li₂O—Cr₂O₃—GeO₂—P₂O₅ glasses, LiZrTiAl(PO₄)₃, LiLaTiO, and lithium aluminum germanium phosphates.

7. The electrochemical cell of claim 1, wherein an active material in the active layer of the anode and an active material in the active layer of the cathode differ from the ceramic material in the heat-resistant coating.

8. The electrochemical cell of claim 7, wherein the active material in the active layer of the anode comprises at least one of a lithium metal oxide, a metal, a metal oxide, and carbon, and wherein the active material in the active layer of the cathode comprises at least one lithiated transition metal oxide.

9. The electrochemical cell of claim 1, wherein an active material in the active layer of the anode and an active material in the active layer of the cathode have a larger particle size than the ceramic material in the heat-resistant coating.

10. The electrochemical cell of claim 1, wherein the active layer of the anode and the active layer of the cathode are thicker than the heat-resistant coating.

11. The electrochemical cell of claim 1, wherein the heat-resistant coating has a thickness from 1 μm to 30 μm and a porosity from 30% to 80%.

12. The electrochemical cell of claim 1, wherein the heat-resistant coating further comprises a polymeric binder material and, optionally, a foam former.

13. The electrochemical cell of claim 1, wherein the heat-resistant coating is applied onto both the active layer of the anode and the active layer of the cathode, wherein the heat-resistant coating on the active layer of the anode and the heat-resistant coating on the active layer of the cathode include different ceramic materials.

14. The electrochemical cell of claim 1, wherein the electrochemical cell lacks a polymeric separator between the anode and the cathode.

15. The electrochemical cell of claim 1, further comprising a polymeric separator between the anode and the cathode, wherein the heat-resistant coating is also applied onto one or both sides of the polymeric separator.

16. A method of manufacturing an electrochemical cell comprising the steps of:
providing an anode comprising:
a conductive layer; and
an active layer applied to the conductive layer;
providing a cathode comprising:
a conductive layer; and
an active layer applied to the conductive layer; and
forming a heat-resistant coating on at least one of the anode and the cathode by directing a powder-gas mixture at high speed toward at least one of the active layer of the anode and the active layer of the cathode.

17. The method of claim 16, wherein the powder-gas mixture includes a ceramic powder and a carrier gas and wherein the high speed of the forming step is 100 m/s or more.

18. The method of claim 17, wherein the carrier gas is at least one of air, nitrogen, helium, and argon heated to a temperature of 100° C. to 450° C. and pressurized to a pressure of 10 atm to 40 atm.

19. The method of claim 17, further comprising the step of placing the anode in electrical communication with the cathode.

20. A method of manufacturing an electrochemical cell, the cell including an anode having a conductive layer and an active layer, a cathode having a conductive layer and an active layer, and, optionally, a separator, the method comprising the steps of:
providing a dry ceramic powder;
combining the dry ceramic powder with a carrier gas to produce a powder-gas mixture; and
directing the powder-gas mixture at high speed toward at least one of the anode, the cathode, and the separator to form a heat-resistant coating on at least one of the anode, the cathode, and the separator.

21. The method of claim 20, wherein the dry ceramic powder has a primary particle size of 0.05 μm to 5 μm, the primary particles being agglomerated into larger particles.

22. The method of claim 20, further comprising the step of mixing the ceramic powder with a dry binder powder.

23. The method of claim 20, wherein the ceramic powder in the heat-resistant coating is a super-ionic conductor ceramic, the heat-resistant coating serving as a solid state electrolyte between the anode and the cathode.

24. A method of manufacturing a solid state electrochemical cell comprising the steps of:
directing a first powder-gas mixture toward a first substrate to form an active layer of an anode;
directing a second powder-gas mixture toward a second substrate to form an active layer of a cathode; and
directing a third powder-gas mixture toward at least one of the active layer of the anode and the active layer of the cathode to form a heat-resistant coating on at least one of the anode and the cathode.

25. The method of claim 24, wherein the second substrate is the heat-resistant coating, the steps being performed in the following order:
(1) directing the first powder-gas mixture toward the first substrate to form the active layer of the anode;
(2) directing the third powder-gas mixture toward the active layer of the anode to form the heat-resistant coating on the anode; and
(3) directing the second powder-gas mixture toward the heat-resistant coating to form the active layer of the cathode.

26. The method of claim 24, wherein the first substrate is the heat-resistant coating, the steps being performed in the following order:
(1) directing the second powder-gas mixture toward the second substrate to form the active layer of the cathode;
(2) directing the third powder-gas mixture toward the active layer of the cathode to form the heat-resistant coating on the cathode; and
(3) directing the first powder-gas mixture toward the heat-resistant coating to form the active layer of the anode.

27. The method of claim 24, wherein each directing step comprises directing a corresponding one of the first, second, and third powder-gas mixtures toward a support at high speed, the support holding a corresponding one of the anode, the cathode, the first substrate, and the second substrate.

28. The method of claim 24, wherein the third powder-gas mixture comprises a Li⁺ conductive solid electrolyte present in the powder from 60 wt. % up to 100 wt. %, and wherein the heat-resistant coating has a porosity from 0% up to 30%.

29. The method of claim 24, wherein each of the first and second powder-gas mixtures comprises a Li⁺ conductive solid electrolyte present in the powder from 0 wt. % up to 40 wt. %, and wherein the active layer of the anode and the active layer of the cathode have porosities from 0% up to 30%.
